(19) United States
(12) Patent Application Publication
(10) Pub. No.: US 2002/0024421 A1
(43) Pub. Date: Feb. 28, 2002

(54) Apparatus and method for preventing data collision in a radio frequency identification tag system

(76) Inventor: Jong-Hoon Kang, Kyoungki-do (KR)

Correspondence Address: MARSHALL, O'TOOLE, GERSTEIN, MURRAY & BORUN, 6300 SEARS TOWER, 233 SOUTH WACKER DRIVE, CHICAGO, IL, 60606-6402, US

(21) Appl. No.: 09/945,482

(22) Filed: Aug. 30, 2001

(30) Foreign Application Priority Data
Aug. 31, 2000 (KR) 2000-51361

(51) Int. Cl. H04Q 5/22

(52) U.S. Cl. 340/10.2

(57) ABSTRACT

A radio frequency identification (RFID) system includes a reader capable of reading data of each RFID device without data collision when a number of contactless smart cards and RFID tags within a radio frequency field and an RFID tag. And, method for preventing data collision in the RFID system includes the steps of transmitting a carrier signal of a predetermined frequency from an RFID reader; determining whether the amplitude of the transmitted carrier signal is modulated; transmitting a first gap signal; first checking whether a tag responsive to a reader signal exists within a read range and reading an initial response of a card; if the tag exists within the tag read range, second checking whether the initial response of the card read leads to data collision; if the initial response does not lead data collision, reading the data stored at memory of the tag with a predetermined protocol; verifying the format of the read data is verified; and if the verified format is valid, generating a second gap signal to notify that data transfer is complete and then repeating the steps from the step of first checking for another card.

### FIELD OF THE INVENTION

The present invention relates to a radio frequency identification (RFID) tag system, and more particularly, to an apparatus and a method for preventing data collision.

### BACKGROUND OF THE INVENTION

Generally, a radio frequency identification (RFID) tag system is applied to identification and security of goods and stocking managing, which is even more functional. In a conventional RFID system, however when a number of tags within a radio frequency field are activated by a reader, identification transfers for the tags lead to data collision. As a result, the reader fails to read the data and the tags are disqualified.

### BRIEF DESCRIPTION OF THE DRAWINGS

Objects and features of the instant invention will become apparent from the following description of preferred embodiments taken in conjunction with the accompanying drawings, in which:

FIG. 1 is a block diagram of an RFID tag reader constructed in accordance with the teachings of the present invention;

FIG. 2 shows a diagram of an RFID tag constructed in accordance with the teachings of the present invention;

FIG. 3 is a transfer timing diagram of a sequential transfer of identification information for each tag to the reader constructed in accordance with the teachings of the present invention;

FIG. 4 provides a diagram of transfer period for each tag constructed in accordance with the teachings of the present invention; and

FIG. 5 is a flow chart of a method for preventing data collision constructed in accordance with the teachings of the present invention.

### DETAILED DESCRIPTION OF THE PREFERRED EMBODIMENTS

Hereinafter, preferred devices and methods constructed in accordance with the teachings of the present invention will be described in detail with reference to the accompanying drawings.

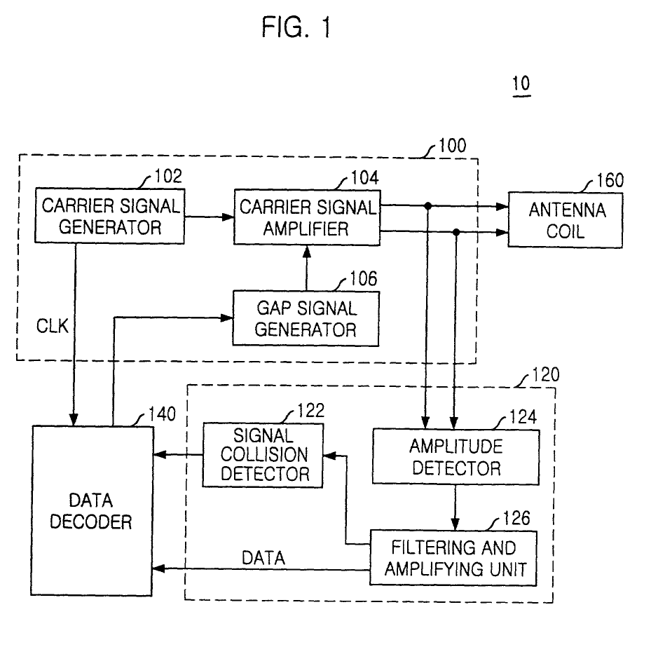

As shown in FIG. 1, an RFID tag reader 10 generally includes a transferring unit 100, a receiving unit 120, a data decoder 140, and an antenna coil 160.

In particular, the transferring unit 100 includes a carrier signal generator 102 that generates a carrier signal. The transferring unit 100 also includes a carrier signal amplifier 104 for amplifying the carrier signal from the carrier signal generator 102. The transferring unit 100 further includes a gap signal generator 106 for generating non-transfer period.

The receiving unit 120 includes an amplitude detector 124 for detecting an amplitude of a read data stream. The receiving unit 120 also includes a filtering and amplifying unit 126 for filtering and amplifying the detected amplitude from the amplitude detector 124. The receiving unit 120 further includes a signal collision detector 122 for receiving an output of the filtering and amplifying unit 126 for detecting data collision.

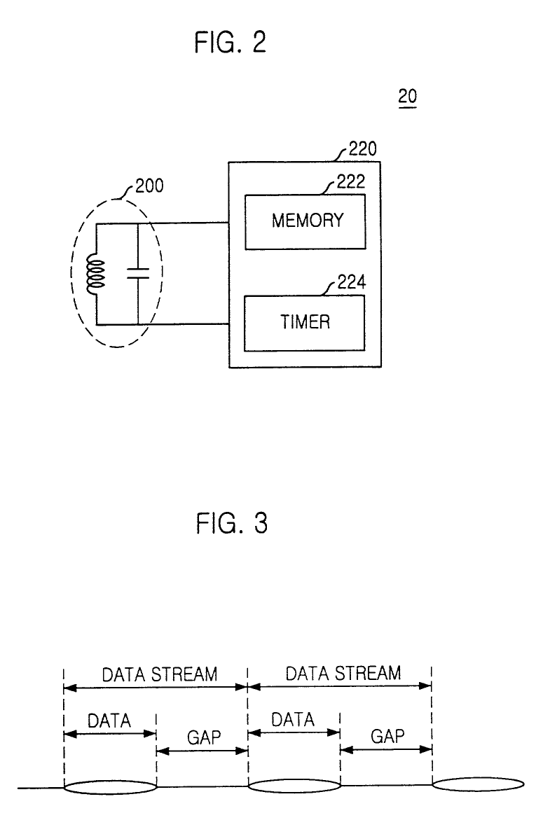

Referring to FIG. 2, an RFID tag 20 includes an antenna 200 matched to a resonance frequency, and an integrated circuit 220 electrically coupled to the antenna 200. The integrated circuit 220 includes a memory 222 for storing data and a timer 224 for generating a non-transfer period.

In an RFID tag system the reader 10 successively transmits a radio frequency signal determined by electromagnetic field strength defining a tag read range. An RFID tag 20 within the tag read range turns on in response to the electromagnetic field transmitted and transfers data stored in the memory 222 by using a predetermined protocol.

FIG. 3 is a transfer timing diagram of the data transmission protocol of the RFID tag systems shown in FIG. 2. The output data of the RFID comprises a data transfer period, i.e. data period, and a non transfer-period, i.e. gap period. The data period has a predetermined uniform length and no data were transmitted for the gap period.

The message to be transferred for the data period is a predetermined data comprising information data bit defined in the data protocol and has a uniform data bit length.

The gap period is generated in the timer of RFID tag system by setting the length information of the gap period. The length of the gap period is longer than that of the data period for the purpose of the prevention of the data collision and the correct data receiving. In a preferred embodiment of the present invention, the gap period is ten times as long as the data period.

The data streams comprising the data period and the gap period are successively outputted if the RFID tags are within the read range and a power is supplied form an antenna and a resonance circuit.

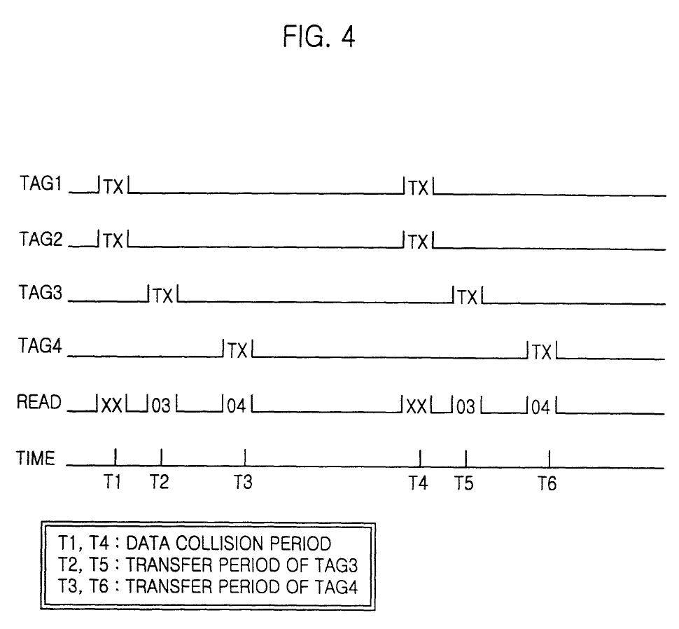

Now referring to FIG. 4, a non-transfer period is typically about 10 times longer than a data transfer period. Even if the non-transfer period is fixed, the absolute value of the non-transfer period between the tags could be varied by a tag manufacturing tolerance.

If an RFID tag 20 is within the tag read range, identification information of the RFID tag 20 is successively transferred to the reader 20 with transfer timing as shown in FIG. 4, at which the data transfer goes along with the non-transfer period.

As shown in FIG. 4, variation of the non-transfer period results in a skew or overlap period with the transfer period for each tag. Even though data collision occurs during a first period T1 and a fourth period T4, the identification information for each tag within the tag read range can be read despite the data collision because the skew period varies as the data transfer period is repeated. During the transfer periods T1 and T4, for example, the identification information for tag 1 and tag 2 cannot be read because a data collision have occurred.

That is, the length of the non-transfer period generated by the timer depends on the tolerance of electric devices in the timer, whereby the length of the non-transfer period varies with the respective RFID tag devices, by a small quantity, and the periodic time of the data stream is different as the respective RFID tag devices. Consequently, it is possible to get a period in which no data collision generated as the repetition of the data transmission even if the data collision generated in the first data transmission period and to get a correct data transmission.

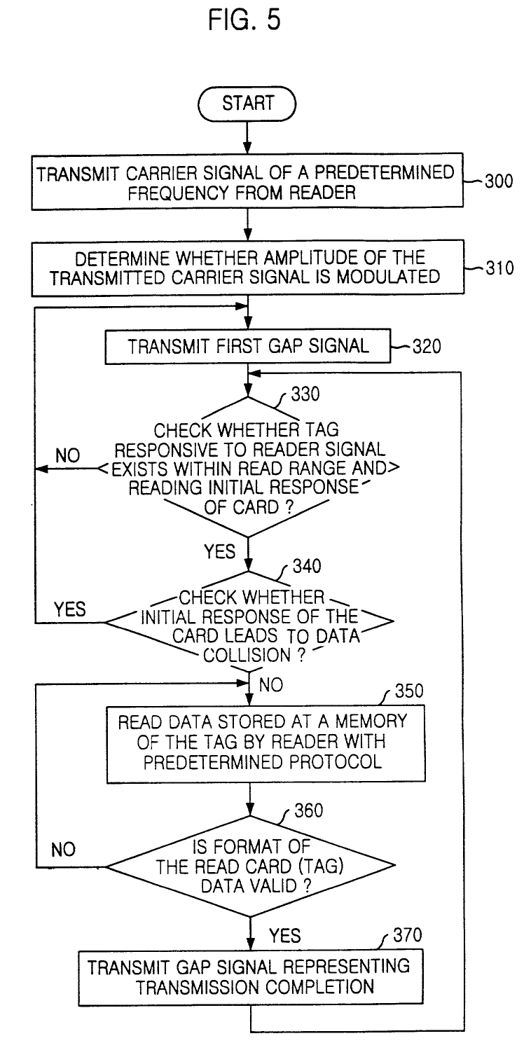

Referring to FIG. 5, a method for preventing data collision in an RFID system begins at step 300 with a reader 10 transmitting a carrier signal at a predetermined frequency. The transmitted carrier signal from the reader 10 is converted DC power of a card (tag) 20 by a power generating circuit of the card 20. The amplitude of the carrier signal is adjusted by using a predetermined data bit rate that is one over 10 or 16 of the carrier frequency and a data state of either logic low or logic high that is determined by the amplitude of the carrier signal.

At step 310, the card (tag) 20 determines whether the amplitude of the transmitted carrier signal is modulated. The modulation of the amplitude depicts that there is a data transfer between the card (tag) 20 and the reader 10.

At step 320, a first gap signal is transmitted by the reader 10 to give a time gap to the successively transmitted carrier signal before the data transfer is started so that the reader 10 can identify the data transfer. And also, the first gap signal stops the data transfer when a number of cards (tags) 20 are within a same tag read range and prevents a number of cards (tags) 20 from simultaneously responding to the carried signal transmitted by the reader 10.

At step 330, it is checked whether a card (tag) 20 responsive to the carrier reader signal is within the read range and reading an initial response of the card (tag) 20. If a card (tag) 20 does not exist within the read range, then the step 320 of transmitting the first gap signal is repeated. However, if a card tag (20) exists within the read range, it is checked whether the initial response of the card (tag) 20 leads to data collision at step 340. If the initial response leads to data collision, the steps from the step 320 are repeated; and, if the initial response does not lead to data collision, the data stored at a memory 222 of the card (tag) 20 is read by the reader 10 with a predetermined protocol at step 350.

At step 360, the format of the read card (tag) data is verified. If the verified format is not valid, step 350 is repeated; and, if the verified format is valid, a second gap signal with a period shorter than that of the first gap signal is generated to notify that the data transfer is complete and then the reader 10 repeats the steps from the step 330 for another card (tag) 20.

Although certain methods and apparatus constructed in accordance with the teachings of the invention have been described herein, the scope of coverage of this patent is not limited thereto. On the contrary, this patent covers all embodiments of the teachings of the invention fairly falling with the scope of the appended claims either literally or under the doctrine of equivalents.

What is claimed is:

1. A radio frequency identification (RFID) reader for preventing data collision in an RFID tag system, the RFID reader comprising:
a transferring unit, wherein the transferring unit includes:
a carrier signal generator for generating a carrier signal determined by electromagnetic field strength defining a tag read range;
a carrier signal amplifier for amplifying the carrier signal from the carrier signal generator; and
a gap signal generator for generating a non-transfer period;
a receiving unit, wherein the receiving unit includes:
an amplitude detector for detecting an amplitude of a read data stream;
a filtering and amplifying unit for filtering and amplifying the detected amplitude from the amplitude detector; and
a signal collision detector receiving an output of the filtering and amplifying unit for detecting data collision;
a data decoder; and an antenna coil.

2. A radio frequency identification (RFID) tag for preventing data collision in an RFID tag system, the RFID tag comprising:
an antenna matched to a resonance frequency; and
an integrated circuit electrically coupled to the antenna.

3. The RFID tag as recited in claim 2, wherein the integrated circuit includes:
a memory for storing data; and
a timer for generating a non-transfer period.

4. A method for preventing data collision in a radio frequency identification (RFID) system, the method comprising the steps of:
a) transmitting a carrier signal of a predetermined frequency from an RFID reader;
b) determining whether an amplitude of the transmitted carrier signal is modulated;
c) transmitting a first gap signal;
d) determining whether a tag responsive to a reader signal is within a tag read range;
e) reading an initial response of a card;
f) if the tag is not within the tag read range, repeating steps c and d;
g) if the tag exist within the tag read range, determining whether the initial response of the card read leads to data collision;
h) if the initial response leads to data collision, repeating steps c through f;
i) if the initial response does not lead to data collision, reading the data stored at a memory of the tag with a predetermined protocol;
j) verifying format of the read data;
k) if the verified format is not valid, repeating steps i and j;
l) if the verified format is valid, generating a second gap signal to notify that data transfer is complete and then repeating steps d through j.

5. The method as recited in claim 4, wherein the carrier signal is determined by electromagnetic field strength defining the tag read range.

6. The method as recited in claim 4, wherein a period of the second gap signal is shorter than that of the first gap signal.
